(19) United States
(12) Patent Application Publication
(10) Pub. No.: US 2012/0056781 A1
(43) Pub. Date: Mar. 8, 2012

(54) APPARATUS AND METHOD FOR ULTRA-FAST GNSS INITIAL POSITIONING SCHEME WITH PEER ASSISTANCE, AND RECORDING MEDIUM THEREOF

(75) Inventors: Seung-Hyun Kong, Daejeon (KR); Wooseok Nam, Busan (KR)

(73) Assignee: Korea Advanced Institute of Science and Technology

(21) Appl. No.: 13/024,807

(22) Filed: Feb. 10, 2011

(30) Foreign Application Priority Data
Sep. 3, 2010 (KR) 10-2010-0086656

(51) Int. Cl. G01S 19/05

(52) U.S. Cl. 342/357.42

(57) ABSTRACT

A method and an apparatus for acquiring an ultra-fast global navigation satellite systems (GNSS) initial position with peer assistance are disclosed. The apparatus includes a communication unit configured to receive assistance generated using a distance from a master terminal to a slave terminal and frequency error of a counterpart's terminal, a communication signal system configured to immediately receive immediately necessary information of the assistance, a Global Positioning System (GPS) receiver configured to rapidly search for a GPS satellite signal using the assistance and continuously track the GPS satellite signal so as to extract a pseudorange, and a computation processor configured to compute the position of the slave terminal using the assistance and the pseudorange. By this configuration, it is possible to perform fast initial position measurement as compared to the existing A-GPS technique, achieve direct communication between two GPS receivers regardless of presence/absence of a mobile communication network, and solve various limitations of the A-GPS technique.

### CROSS-REFERENCE TO RELATED APPLICATION

This application claims priority to Korean Patent Application No. 10-2010-0086656, filed on Sep. 3, 2010, and all the benefits accruing therefrom under 35 U.S.C. §119, the contents of which in its entirety are herein incorporated by reference.

### TECHNICAL FIELD

The present disclosure relates to a technique of rapidly measuring an initial position of a global navigation satellite systems (GNSS) receiver with high sensitivity, and, more particularly, to an apparatus and a method for rapidly acquiring an initial position (cold start) of a GNSS receiver with peer assistance, and a recording medium thereof.

### BACKGROUND

Global navigation satellite systems (GNSS) is a generic term for a position determination system using a satellite network, such as the Global Positioning System (GPS), which measures a Time of Arrival (TOA) of a signal transmitted from a satellite antenna to a GPS receiver and detects the position of the satellite when the signal is transmitted from the satellite, thereby computing a relative position of the GPS receiver. Since the GPS receiver is not accurately aware of its three-dimensional coordinates (x, y, z) and time t, TOAs are measured from four satellite signals and the positions of the GPS satellites transmitting the signals are computed using the TOAs, thereby relatively measuring the position of the GPS receiver.

In order to implement such a system, a satellite signal needs to be searched for and satellite information needs to be acquired. Not only the GPS but most other GNSS (which is a generic term for satellite navigation systems including the GPS) utilize a spread-spectrum scheme. A GPS L1 frequency coarse/acquisition (C/A) signal has a code period of 1023 chips in a bandwidth of 1 MHz and each code chip has a time width of about 1 μsec (microsecond). Accordingly, the GPS C/A code including 1023 chips is repeatedly transmitted with a time period of 1 msec (0.001 second). GPS satellites have different C/A codes each having a length of 1023 chips.

The position measurement of the GPS receiver may be subdivided into three scenarios. A scenario in which the GPS receiver measures an initial position after maintaining a power-off state for a long period of time is called a cold start. The time required in this case is referred to as a Time to First Fix (TTFF).

The cold start of the GPS receiver for searching for the GPS L1 frequency C/A signal is performed through the following steps. The times in parentheses denote the time consumed for performing each step. The steps include power-on (less than 1 second) of the GPS receiver, search (less than a maximum of 15 seconds, which is different depending on GPS receivers) for a hypothesis range of a code phase of each satellite signal (including 1023 code chips in the case of the GPS L1 frequency the C/A code) and a Doppler frequency range (The Doppler frequency hypothesis is generally set every 50 Hz from −5 kHz to +5 kHz in the case of a GPS receiver for a pedestrian on the ground.), confirmation (less than several seconds) of acquisition of each satellite signal from the search result, navigation data collection (30 seconds to 12 minutes) necessary to compute the position at a data frame of the acquired satellite signal, and position measurement computation (less than several seconds) of the GPS receiver when collecting all navigation information of four or more satellites).

A general GPS receiver performs position determination using a C/A signal received with an L1 frequency. The C/A signal is a of a GPS navigation message, which is subjected to spread-spectrum with a Gold code uniquely allocated for each GPS satellite, also called the pseudorandom noise (PRN) code. Since the PRN code of the GPS C/A signal with a code length of 1023 chips is generated with a period of 1 millisecond, one code (=1 chip) has a time length of about 1 microsecond (For reference, the signal propagates 300 meters in 1 microsecond.). Accordingly, in order to enable the GPS receiver to search for and acquire the C/A signal, code synchronization with the PRN code of the GPS satellite signal received at a certain instant is performed and frequency synchronization with the Doppler frequency of the GPS satellite is performed. However, since the GPS receiver in the cold state step does not have information about the code and the Doppler frequency of the currently received signal, signal search is performed over the entire code hypothesis range and the entire Doppler frequency hypothesis range.

FIG. 1 shows a result of searching 200×2035=407000 hypotheses in order to enable the general GPS receiver to search all the code phase hypotheses (1023 chips in units of ½ chips->a total of 2035 (=2036−1) code phase hypotheses) and all the Doppler frequency hypotheses (from −5 kHz to +5 kHz in 50-Hz units, a total of 200 frequency hypotheses) for one satellite signal. The x-y plane of FIG. 1 is a 407000-hypothesis plane, and an output value of a correlator (or integrator) of each point (each hypothesis) on the hypothesis plane is shown on the z axis. The output of the correlator is obtained by operating a correlator having a correlation length of 10 msec for each hypothesis (i.e., code or Doppler frequency hypothesis). If a correlator having a longer correlator length is used to search for a weak signal, the Doppler frequency hypothesis is searched for in a smaller unit. In the case of a GPS receiver without parallel correlators, the time consumed for searching for one satellite signal using one correlator having a length of 10 msec becomes a maximum of 0.01 (sec)×407000 (number of hypotheses)=4070 sec. If the GPS receiver has 1000 parallel correlators, the time consumed for searching for one satellite signal is a maximum of 4.07 sec. And, if the GPS receiver having 1000 parallel correlators performs correlation of 20 msec, the number of Doppler frequency hypotheses is doubled. Accordingly, since a maximum of 814000 hypotheses are searched for, the time consumed for searching for one satellite signal is a maximum of 0.02×814000/1000=16.28 sec. The time consumed when a GPS receiver having one hundred thousand parallel correlators searches for one satellite signal is a maximum of 0.1628 sec. Since the newest GPS receiver uses at least one hundred thousand correlators having a correlation length of few seconds, a considerable amount of time is needed to acquire a satellite signal.

Then, the GPS receiver which acquires the C/A signal of each GPS satellite receives a navigation message of the GPS satellite using a de-spreading process from the received C/A signal. Since the navigation message of the GPS has a low data rate of 50 bps and a message received from one GPS satellite is about a total of 1500 bits, in order to complete the code start, data reception for about 30 seconds is necessary for each GPS satellite after acquiring the satellite signal.

FIG. 2 is a diagram comparing initial position search time (TTFF) at the cold start between an Assisted GPS (A-GPS) (or an assisted GNSS) receiver of Qualcomm Inc. and an existing GPS receiver.

As shown in FIG. 2, the TTFF of the A-GPS is within several seconds thanks to the assistance of an A-GPS server connected to a mobile communication base station. The A-GPS receiver has excellent performance as compared to the existing GPS technique, but has several restraints and problems as follows.

First, since the assistance is received from the server connected to the mobile communication network, the A-GPS may be implemented only when wireless communication is possible. This disables the A-GPS to be implemented in an area (e.g., sea, air, suburbs, mountainous area or desert) other than a mobile communication service area.

Next, a code phase range searched by the GPS receiver varies according to time synchronization between a base station and a mobile phone and position estimation accuracy of the mobile phone. In a mobile communication network, if the position of the mobile phone is detected only in the base station area, a code phase area searched by the GPS receiver mounted in the mobile phone may not be reduced within a range from −30 to 30 μsec in the base station area having a radius of 9 km (a distance of 30 μsec in terms of a transmitted signal). In general, if one GPS C/AQ code chip is about 1 μsec and two code phase hypotheses are searched per one code chip, an area corresponding to 60×2=120 code phase hypotheses has to be searched. Since the base station area has a radius of several km in the case of a downtown area and has a radius of 20 km in the case of a suburban area, more code phase hypotheses have to be searched in the case of the suburbs.

The Doppler frequency information of each satellite, which is measured by the base station, is similar to the Doppler frequency of each satellite, which is measured by the GPS receiver of the mobile phone within the base station area, and thus is very useful in reducing the Doppler frequency search area of the GPS receiver of the mobile phone. However, since the base station is not aware of the Doppler frequency due to the frequency error of an oscillator used in the mobile phone or due to the motion of the mobile phone (e.g., in a vehicle), the Doppler frequency region may not be reduced further.

In addition, in the case of a 3rd-, 3.5th-, or 4th-generation asynchronous cellular network, the base station time is inaccurate and the size of the code phase search area becomes 1023 chips, i.e. the entire search area of the existing GPS receiver. Thus, the performance of the A-GPS may deteriorate as compared to a 2nd-generation mobile communication system.

The A-GPS is not applicable to a very small area, a small area, the size of which may be scaled up or down, or an area adjacent to a certain reference point (no scalability). Also, the A-GPS is not applicable to an area adjacent to a new reference point set by the movement of a certain reference point (no coverage mobility). This is because the base station and the GPS receiver are fixed.

In order to deliver assistance from the A-GPS server to the terminal according to the mobile communication standard, various high-performance channel coding schemes (encoding, interleaving, scrambling, etc.) are used in a process of establishing a connection to suit a deliver protocol per layer and formatting the assistance to a message of the mobile communication standard. Thus, the terminal may not immediately use the assistance even when the terminal receives the signal including the assistance. That is to say, the terminal can obtain the assistance included in the message only after successfully performing a channel decoding process (descrambling, deinterleaving, decoding, etc.) with respect to the signal including the assistance. Accordingly, the assistance cannot be obtained immediately.

### SUMMARY

The present disclosure is directed to providing an ultra-fast GNSS initial position acquisition apparatus with peer assistance, which is capable of implementing a mutual communication scheme for enabling fast code start of a Global Positioning System (GPS) receiver by information delivery between GPS receivers, an improved communication signal system and standard for delivering assistance so as to enable fast GPS cold start, and a peer assistance scheme between GPS receivers so as to enable fast cold start.

The present disclosure is also directed to providing an ultra-fast GNSS initial position acquisition method with peer assistance, which is applied to the ultra-fast global navigation satellite systems (GNSS) initial position acquisition apparatus with the peer assistance.

The present disclosure is also directed to providing a computer-readable recording medium having recorded thereon a program for executing the ultra-fast GNSS initial position acquisition method with the peer assistance on a computer.

In one aspect, there is provided a GPS receiver apparatus for enabling fast cold start with peer assistance, which is integrated in a slave terminal, wherein the slave terminal which is wirelessly connected to a master terminal having a GPS receiver which successfully performs position acquisition and normally operates includes a communication unit configured to wirelessly deliver assistance generated by the master terminal to the slave terminal, measure a distance between the master terminal and the slave terminal, and measure frequency error of a counterpart's terminal from the signal transmitted from the counterpart's terminal, a signal system configured to utilize a direct spread scheme for enabling more fast information delivery while a communication scheme for transmitting the assistance from the master terminal to the slave terminal does not follow a message form, a computation processor of the master terminal configured to compute a distance from the position of the master terminal to a GPS satellite and generate the assistance to be delivered to the slave terminal, and a GPS receiver configured to search for and track the GPS satellite signal using the assistance received from the master terminal.

In another aspect, there is provided a GPS cold start method with peer assistance including measuring a relative distance through mutual wireless communication by a slave terminal or a master terminal, obtaining frequency error information of a counterpart from a counterpart's signal through the mutual wireless communication by the master terminal or the slave terminal, generating assistance by the master terminal using the measured frequency error or mutual distance information and wirelessly receiving the assistance by the slave terminal through wireless communication, searching for a GPS satellite signal using the assistance received by the slave terminal and acquiring the GPS satellite signal, and computing an accurate pseudorange using the received assistance and the searched GPS satellite signal and computing the position of the slave terminal.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram showing a result of searching a two-dimensional Global Positioning System (GPS) signal hypothesis search area including all code phase hypotheses and all Doppler frequency hypotheses in order to enable a general GPS receiver to search for one satellite signal;

FIG. 2 is a diagram comparing initial position search time (TTFF) at a cold start between an Assisted GPS (A-GPS) receiver of Qualcomm Inc. and an existing GPS receiver;

FIG. 3 is a schematic diagram showing the functions of a master terminal and a slave terminal according to an embodiment;

FIG. 4a is a diagram showing the detailed function of a master terminal according to an embodiment;

FIG. 4b is a diagram showing the detailed function of a slave terminal according to an embodiment;

FIG. 5 is an operation flow illustrating a GPS system with peer assistance, which enables a fast GPS cold start with peer assistance, according to an embodiment;

FIG. 6 is a diagram showing only mandatory assistance for peer assistance according to an embodiment;

FIG. 7 is a diagram showing a signal generation method for quickly transmitting main assistance from a master terminal to a slave terminal, according to an embodiment;

FIG. 8 is a diagram showing the function of a receiver for quickly receiving main assistance of a master terminal in a slave terminal according to an embodiment;

FIG. 9 is a flowchart illustrating the function of a slave terminal which receives assistance according to an embodiment;

FIG. 10 is a diagram showing an example of a transmitter of a wireless communication modem 242 in a mater terminal 300;

FIG. 11 is a diagram showing an example of a satellite signal output from a satellite signal generator 1002 of FIG. 10;

FIG. 12 is a diagram showing a frequency synchronization process of a receiver of a wireless communication modem 342 of a slave terminal 300; and

FIG. 13 is a process of acquiring a code phase of each global navigation satellite systems (GNSS) satellite signal in another correlation process in a wireless communication modem 342 of a slave terminal 340.

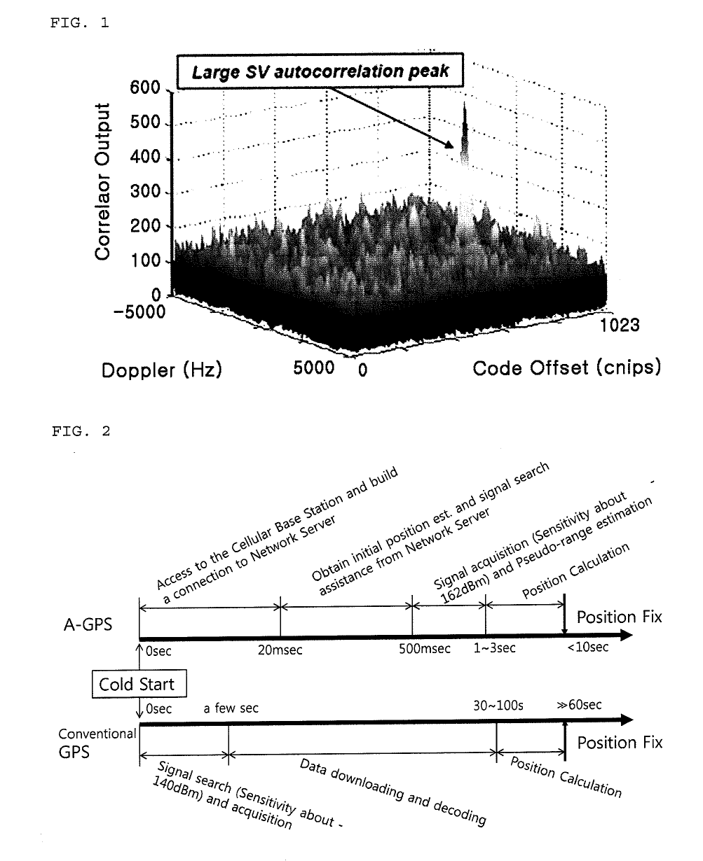

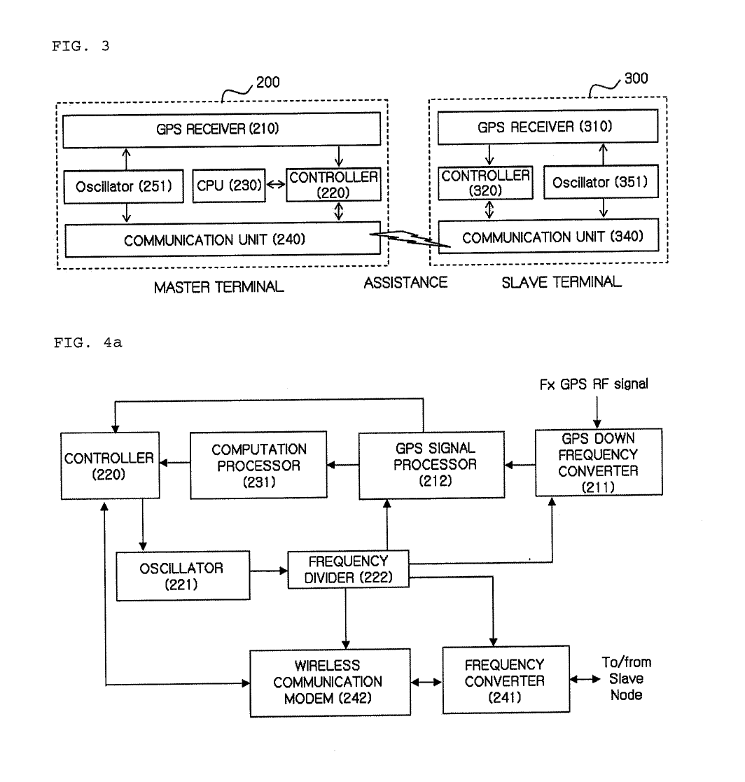

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

The global navigation satellite systems (GNSS) encompass all the satellite navigation systems [the Global Positioning System (GPS) of the United States, the Global Navigation Satellite System (GLONASS) of Russia, the Galileo of Europe, the Beidou of China, and the Quasi-Zenith Satellite System (QZSS) of Japan]. In the present disclosure, GNSS and GPS are used interchangeably. Since both the GNSS and GPS use spread-spectrum signals, all implementation examples of the GNSS receiver are similar to implementation examples of the GPS receiver and thus the GNSS and the GPS have the same meaning, unless specified otherwise.

Recently, with the development of the communication technique, a technique of performing peer-to-peer communication between terminals has been developed. In a method of performing communication among a plurality of terminals, wireless communication may be performed using various schemes such as a peer-to-peer (P2P) scheme or an ad-hoc scheme, including a cooperative scheme for assigning the same right to the terminals such that the terminals cooperate with each other and a scheme for setting a specific terminal as a master terminal and setting the terminals located in a master terminal area or the terminals which newly enter the master terminal area as slave terminals. Recently, in the case of the IEEE 802.15.4a (the international standard of a personal area communication scheme), a scheme for performing communication between terminals and performing distance measurement within a local area or a personal area (tens of meters for indoors, and 200-300 m for outdoors) was employed. Even in the case of WiFi defined in the IEEE 802.11, an ad-hoc based organic communication network configuration between terminals is possible so as to establish communication between the terminals.

In the present disclosure, a technique of generating assistance in a GPS receiver which successfully performs GPS position measurement and transmitting the assistance to a GPS receiver which begins a cold start so as to perform fast initial GPS position measurement using a communication scheme for enabling communication between terminals is proposed. This is referred to as Peer Assisted GPS (PA-GPS).

FIG. 3 is a schematic diagram showing the functions of a master terminal and a slave terminal according to an embodiment.

First, a master terminal (master node) 200 and a slave terminal (slave node) 300 are movable and respectively include communication units 240, 340 to enable real-time wired/wireless data communication with each other. Each terminal (node) is equipped with a GPS receiver 210, 310 and a controller 220, 230 for controlling the GPS receiver and the communication unit. In particular, the mater terminal includes a central processing unit (CPU) 230, which processes the output of the GPS receiver 210 and a variety of information extracted by the master terminal according to a suitable algorithm, generates assistance for a cold start of the slave terminal, and transmits the assistance to the slave terminal which requests the assistance. The terminals (nodes) include oscillators 250, 350 and supply clock signals and reference frequency signals of the oscillators to the GPS receiver 210 and the communication unit 240 of the master terminal 200 and to the GPS receiver 310 and the communication unit 340 of the slave terminal 200, respectively.

In the present disclosure, the master terminal 200 and the slave terminal 300 are close to each other so as to directly perform wireless communication therebetween. It is assumed that the slave terminal 300 currently begins the cold start of the GPS receiver 210 and the master terminal 200 successfully operates the GPS receiver so as to perform stable position measurement and GPS satellite signal tracking.

Communication for transmitting information between the master terminal and the slave terminal as shown in FIG. 3 may be implemented using various schemes. In the present disclosure, in particular, it is assumed that all communication schemes of a local area or a personal area, such as WiFi, WLAN (IEEE 802.11), ZigBee (IEEE 802.15.4), or WPAN (IEEE 802.15.4a), are possible. Among the existing mobile communication schemes (IS-95, IS-2000, UMTS, GSM, WiBro, WiMAX, etc.), since communication between a base station and a mobile phone using a femtocell (a radius of tens of meters) or a picocell (a radius of 100-200 m) is short-distance communication, the communication scheme thereof may be used as the communication scheme between the master terminal and the slave terminal used in the present disclosure. Accordingly, the short-distance communication method between the master terminal and the slave terminal used in the present disclosure will be described based on the basic connection standard and protocol generally used in the above-described communication methods.

FIG. 4a is a diagram showing the detailed function of a master terminal 200 according to an embodiment.

The master terminal 200 receives each GPS satellite signal, frequency converts each GPS satellite signal into a baseband or intermediate frequency using a GPS down frequency converter 211, and outputs the converted signal to a GPS signal processor 212. The GPS signal processor 212 performs GPS satellite signal search and acquisition and signal tracking using a correlator and transmits a code phase and a Doppler frequency of each GPS satellite signal to a computation processor 231 in real time. In the general GPS receiver, the correlator has two inputs: a continuous signal sample data of a baseband or intermediate GPS signal received in real time; and a signal obtained by combining a Doppler frequency component to a unique spread code (C/A code in the case of the GPS L1 frequency) of a GPS satellite signal generated by the GPS receiver. An example thereof is shown in Equation 1.

C/A signal of s-th GPS satellite signal having internally generated code phase delay τ=PRNₛ(t−τ) *cos(2n(f_{IF}+f_{Doppler})t) Equation 1

In general, the output of the correlator becomes a maximum value when the code phases and the Doppler frequencies of the two inputs of the correlator coincide with each other. Accordingly, if the output of the correlator is a maximum value, the code phase and the Doppler frequency of the GPS satellite signal input to the correlator (by successful GPS signal search) is equal to the code phase and the Doppler frequency of the currently received GPS satellite signal and is transmitted from the GPS signal processor 212 to the computation processor 231.

The computation processor 231 computes the position of the master terminal 200, extracts a navigation message from each GPS satellite signal, generates a measurement value necessary for assistance to be delivered to the slave terminal 300 from the navigation message, and transmits the measurement value to the controller 220.

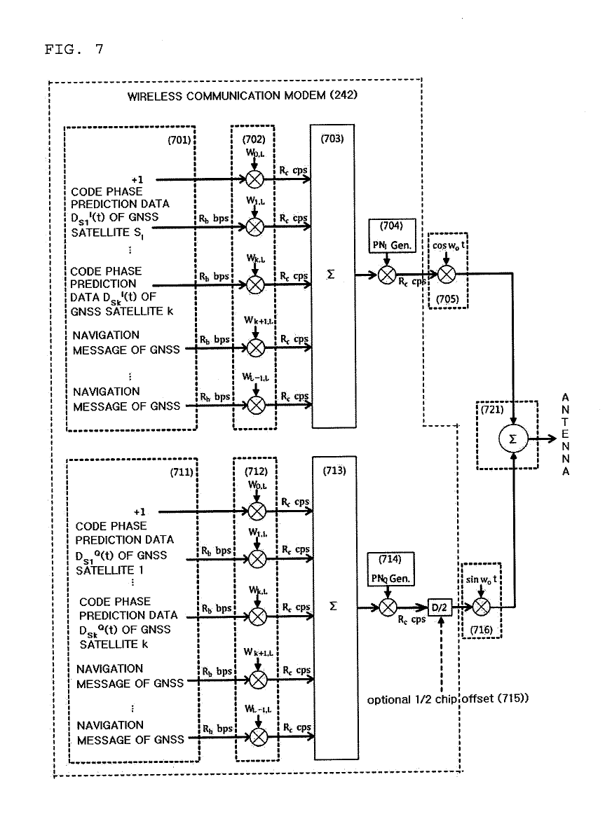

The controller 220 receives the output information of the GPS signal processor 212 and the computation processor 231, generates the assistance to be delivered to the slave terminal 300 from the input information, and delivers the assistance to a wireless communication modem 242 periodically or if a request is received from the wireless communication modem 242. The assistance includes the mandatory element information shown in FIG. 6. A second function (optional function) of the controller 220 is to control the oscillator 221 using a voltage control scheme or a numerical control scheme. The control of the oscillator 221 by the controller 220 is performed equally in the master terminal 200 and the slave terminal 300.

The computation processor 231 may measure the output result of the GPS signal processor 212 and measure the output frequency signal error of the oscillator 221 supplied from a frequency divider 222 to the GPS down frequency converter 211 and the GPS signal processor 212. The measured output frequency error information of the oscillator 221 is input to the controller 220 and the controller 220 transmits a control signal for adjusting the frequency of the oscillator 221 so as to adjust the output frequency of the oscillator 221 (The frequency feedback control by the controller 220 is not mandatory but optional in the present embodiment.).

The assistance output of the controller 220 is transmitted to the wireless communication modem 242 and is input to the frequency converter 241 and the output of the frequency converter 241 is wirelessly transmitted to the slave terminal 300 via an antenna.

A master terminal 200 which is equal to the master terminal 200 shown in FIG. 4a in design but is different therefrom in the functions of the configuration modules may also be employed.

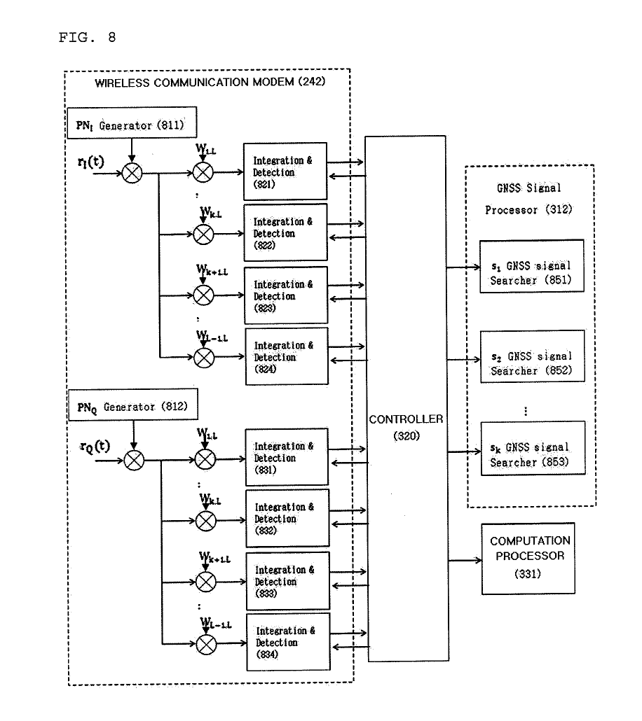

For example, if the mandatory assistance shown in FIG. 6 is not included in the above-described assistance message, the information shown in FIG. 6 may be transmitted by a communication signal generated by the communication modem 242 so as to transmit the assistance. For the transmission of the assistance using the communication signal, a special communication signal structure needs to be designed. In the present disclosure, a signal design example using orthogonal spreading and direct spreading schemes will be described with reference to FIGS. 7, 8 and 9.

In another implementation example, while the slave terminal 300 which receives the assistance from the master terminal 200 tries a cold start, the controller 220 may stop frequency control such that the frequency of the oscillator 221 is not changed. In a method of measuring the frequency error information of the counterpart and utilizing assistance in consideration of the frequency error information of the counterpart, if any one frequency is changed while the slave terminal performs the cold start, error may occur in another frequency in a process of correcting the measured frequency error. That is to say, the master terminal 200 or the slave terminal 300 observes the frequency error of the signal generated by the counterpart's terminal (master or slave) and corrects the frequency error in the Doppler frequency value of the GPS satellite signal transmitted from the master terminal 200, thereby utilizing the corrected frequency value of the GPS satellite signal. Accordingly, the control of the controller is stopped such that the frequency generator of the master or slave terminal does not generate a changed frequency.

FIG. 4b is a diagram showing the detailed function of the slave terminal 300 according to an embodiment.

When the slave terminal 300 is powered on, a controller 320 operates a communication unit 342 so as to search for the signal transmitted from the master terminal 200, exchanges information with the master terminal 200 through the communication unit 342, and generates and transmits controls signals of the modules shown in FIG. 4b.

An oscillator 321 is controlled using a voltage control scheme or a numerical control scheme so as to generate a reference frequency signal used by the functional modules of the slave terminal 300. The generated reference clock signal is subdivided into various clock signals having various frequencies required by the modules by a clock divider 322 to be distributed to the modules (Although the clock divider 322 includes a plurality of clock dividers, the clock divider is shown as one block for convenience). For example, the clock frequency transmitted from the clock divider 322 to the GPS down frequency converter 211 has a value close to about 1.575 GHZ in the case of an L1 GPS satellite signal (Central frequency is 1.575 GHZ.). In the case where the output of the GPS down frequency converter 311 is a baseband signal and the GPS down frequency converter 311 performs direct down frequency conversion without IF frequency, the clock frequency transmitted to the GPS down frequency converter 211 becomes 1.575 GHz. As another example, if the central frequency of the IF output of the GPS down frequency converter 311 of the L1 GPS satellite signal is 50 MHz, the clock frequency transmitted to the GPS down frequency converter 311 is exactly 1.525 GHz.

The GPS satellite signal down frequency converted by the GPS down frequency converter 311 is delivered to a GPS signal processor 312 and the GPS signal processor 312 processes the down frequency converted GPS satellite signal according to a control signal received from the controller 320. The GPS signal processor 312 serves to search for, acquire and track the currently received GPS satellite signal according to the control signal of the controller 320 using a plurality of correlators. That is, similarly to the operation of a general GPS correlator, the correlator correlates two inputs (a sample signal of the currently received GPS satellite signal and each GPS satellite signal having a code phase and a Doppler frequency generated under the control of the controller 320 (see Equation 1)). If the internally generated GPS satellite signal has the same code phase and Doppler frequency as the received GPS satellite signal, the output of the correlator for searching for the GPS satellite has a maximum value. Then, the signal processor 312 serves to continuously track the searched GPS satellite signal and extract an accurate GPS code phase each time. The extracted code phase value of the GPS satellite signal is transmitted to the controller 320.

A computation processor 331 receives the code phase value of each GPS satellite signal extracted by the signal processor 312 and various assistances received from the master terminal 200 through the controller 320 so as to compute the position of the slave terminal 300. In general, in the case of the C/A code signal carried in the L1 frequency channel which is mainly used to perform the position measurement of the GPS, since a pseudorandom noise (PRN) code of 1023 chips is transmitted exactly in 1 millisecond, a temporal length of one code phase is expressed by one chip, i.e. 1/1023 millisecond (about 1 microsecond). The code phase of the received GPS satellite signal indicates where the currently received PRN code is located in 1023 chips (i.e., how much time is spent from a last code period) and one chip is expressed by a 1/10 to 1/100 chip according to the accuracy of the correlator. For example, 11.51 chips from the start of the PRN code indicate a time when passing through 11 and 0.51 chips. In general, the altitude of the GPS satellite is 20200 km or more above the ground and thus has a value of 67.3 milliseconds (67 PRN code periods and a code phase of about 300 chips) in terms of time. Accordingly, a psedorange between the GPS satellite and the GPS receiver (slave terminal 300) is computed by the number N of repetitions of the PRN code generated between each GPS satellite and the slave terminal 300 and the phase of the PRN code. The number N of repetitions of the PRN code of each satellite may be transmitted from the master terminal as a part of the assistance, but is not included in the mandatory assistance transmitted from the master terminal to the slave terminal. In the present disclosure, measured values necessary for measuring the distance between a certain GPS satellite s and the slave terminal 300 by the computation processor 331 are equal to those of the algorithm developed for the A-GPS of Qualcomm Inc. That is, the following equations are obtained by 1) a current time T_rx extracted by the slave terminal 300, 2) a PRN code phase Ps1 of an s-th GPS satellite signal received by the slave terminal 300 at the current time T_rx, 3) a past time T-tx when the s-th GPS satellite signal received at the current time T_rx is transmitted from the antenna of the s-th satellite, 4) a PRN code phase Ps0 of the s-th GPS satellite signal transmitted from the s-th GPS satellite at the current time T_rx, 5) a positional shift component Del_PR in the slave terminal direction of the positional shift of the s-th GPS satellite at the current time T_rx based on the position of the s-th GPS satellite at the past time T_tx, 6) the number Ns of repetitions of the PRN code generated between the s-th GPS satellite and the slave terminal 300, and 7) various error components (Misc_PR_error−time error of the satellite and the receiver, time delay error generated in propagation of the ionospheric layer and the atmospheric layer and a distance measurement error generated due to navigation model and measurement error).

Pseudorange=c*(T_{—}rx−T_{—}tx)+Misc_{—}PT_error Equation 2

c*(Ps1−Ps0)*0.001/1023+c*0.001*Ns+Del_{—}PR+MISC_PR_error Equation 3

In Equation 2, c denotes the speed of signal propagation (=velocity of light) and 0.001 is a millisecond value. Equation 3 may be used for position measurement by the peer assistance scheme of the slave terminal 300 according to the present disclosure, Ps1 is extracted by the signal processor 312 of the slave terminal 300, Ps0 is obtained from the orbit of the satellite and time information included in the assistance received from the master terminal 200, and Ns and Del_PR_rate (Del_PR/second) may be included in the assistance measured by the master terminal 200 and transmitted to the slave terminal 300. The computation processor 331 adjusts the Ns value in consideration of Ps1 and Ns received from the master terminal 200, Ps0 measured by the computation processor 332, and motion of the s-th GPS satellite in a time interval T_delta=T_rx−T_tx between the current time T_rx and the past time T_tx. For example, if the time interval T_delta is 0 or if the assistance transmitted from the master terminal 200 is a predicted value which becomes valid at a specific time after the time interval T_delta, since a variation in NS due to the motion of the s-th GPS satellite generated during the time interval T_delta may be ignored, if the code phase value received from the master terminal 200 is large but the code phase value measured by the slave terminal 300 is small, Ns is set added by 1 (+1) and, in the opposite case, Ns is set subtracted by 1 (−1). If T_delta is not a sufficiently short time (for example, if it is 0.1 millisecond or longer), the increase/decrease width of the code phase which may be generated due to the motion of the GPS satellite during T_delta is significantly grater than that of the above example. Accordingly, the Ns value needs to be compensated for in consideration of the increase/decrease of the code phase which may vary during T_delta.

The computation processor 331 receives other assistance necessary for the position computation of the slave terminal 300 from the master terminal 200 using the wireless communication modem (baseband communication modem) 342 and a frequency converter 341, in addition to the code phase value of the GPS satellite signal transmitted to the slave terminal 300. The GPS signal processor 312, the GPS down frequency converter 311, the frequency converter 341 and the wireless communication modem 342 respectively receive frequency signals having necessary frequencies from the frequency divider 322, and the frequency divider 322 divides the reference frequency signal generated by the oscillator 321 using the voltage control or numerical control scheme so as to generate higher frequency signals. Accordingly, if error occurs in the output signal (reference frequency signal) of the oscillator 321, the error is delivered to all the modules, i.e., to the GPS signal processor 312, the GPS down frequency converter 311, the wireless communication modem 342 and the frequency converter 341.

The wireless communication modem 342 performs communication with the master terminal 200 through the frequency converter 341 and transmits information obtained from the master terminal 200 to the controller 320. At this time, in one implementation example of the present disclosure, the master terminal 200 receives and analyzes the signal from the signal transmitted from the communication unit (the wireless communication modem 342 and the frequency converter 341) of the slave terminal 300, measures the frequency error of the signal transmitted from the slave terminal 300, and transmits the error value to the slave terminal 300. In another implementation example of the present disclosure, the master terminal 200 may not measure the signal transmitted from the slave terminal 300 and may not obtain the frequency error information, but the slave terminal 300 may compute a difference between the frequency of the slave terminal and the frequency of the signal transmitted from the master terminal. In this case, the slave terminal 300 maintains the frequency of the oscillator 351 without correcting the frequency of the oscillator 351 from a time when the signal of the master terminal 300 is measured and the frequency of the signal of the master signal is compared with the frequency of the signal of the slave terminal when the modules 311, 312 of the GPS receiver search for and acquire the GPS signal.

With the design of FIG. 4 as a base, various implementation methods are possible in the present disclosure. In a first implementation example, the assistance is included in a message and is transmitted from the master terminal 200 to the slave terminal 300.

In a second implementation example, in order to enable the slave terminal to more rapidly acquire the assistance than in the first implementation example, the assistance is not included in the message, but is expressed by the communication signal (modulated signal) between the communication units 240, 340 respectively included in the master terminal 200 and the slave terminal 300. The second implementation example will be described in detail with reference to FIGS. 7, 8 and 9.

In a third implementation example of the present disclosure, the master terminal 200 receives and compares the signal transmitted from the slave terminal 300 with the output of the oscillator 251 of the master terminal, observes the output frequency error of the oscillator 351 of the slave terminal 300, compensates for the frequency error with the Doppler frequency value of each GPS satellite included in the assistance generated by the first or second implementation example.

In a fourth implementation example of the present disclosure, on the contrary to the third implementation example, the slave terminal 300 receives and compares the signal transmitted from the master terminal 300 with the output of the oscillator 351 of the slave mater, observes the output frequency error of the oscillator 251 of the master terminal 200, and compensates for the frequency error with the Doppler frequency value of each GPS satellite included in the assistance generated by the first or second implementation example.

In a fifth implementation example of the present disclosure, unlike the third and fourth implementation examples of the present disclosure, the Doppler frequency value is used without observing the frequency error of the counterpart. In this case, since errors may occur in the Doppler frequency component obtained from the assistance, the slave terminal 300 has a wider Doppler frequency hypothesis window than in the third and fourth implementation examples.

In a sixth implementation example of the present disclosure, the mater terminal 200 and the slave terminal 300 perform mutual distance measurement and the measured distance is used in the generation of the assistance or a determination as to whether the terminals are close to each other.

In a seventh implementation example of the present disclosure, the master terminal 200 generates the assistance when the slave terminal 300 makes a request for the assistance.

In an eighth implementation example of the present disclosure, the master terminal 200 periodically generates the assistance and broadcasts the assistance.

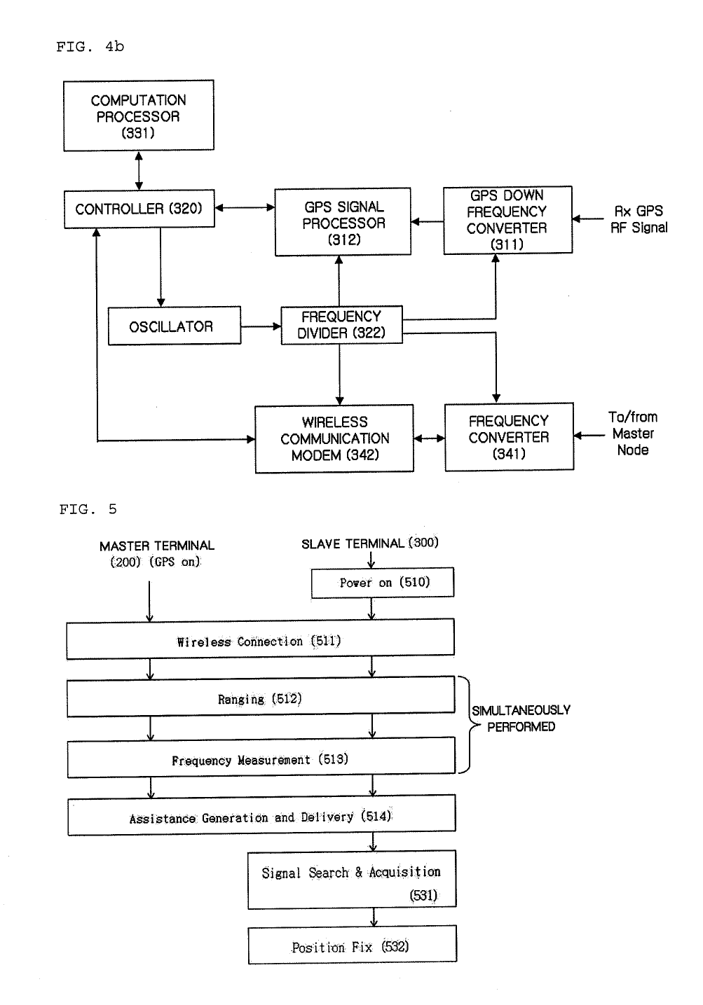

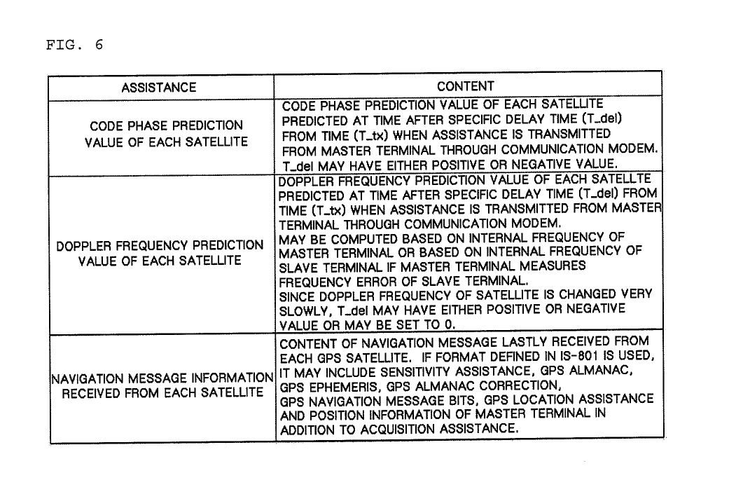

FIG. 5 is a generalized operation flow illustrating a GPS system with peer assistance, which enables a fast GPS cold start with peer assistance, according to an embodiment.

The master terminal 200 is already in a power on state in which the GPS is initialized. That is to say, the GPS satellite signal has been tracked during a sufficient time and the master terminal is aware of its accurate position. When slave terminal 300 is powered on (510), a wireless connection is performed (511). In the connection stage (511), in the seventh implementation example of the present disclosure, the slave terminal 300 sends a signal (or a message) for requesting assistance to the master terminal 200 and, in the eighth implementation example, the slave terminal 300 receives a signal (or a message) periodically broadcasted by the master terminal 300 and acquires assistance from the received signal (or message) without requesting the assistance to the master terminal 200. Since the present disclosure may be implemented in all the communication standards supporting the existing peer-to-peer communication and ad-hoc connection, the request for the assistance or the broadcast of the assistance in the connection stage 511 is performed by a scheme defined in the communication standard.

A next stage is a ranging stage (512) of performing distance measurement between the master terminal 200 and the slave terminal 300. The distance measurement scheme may be a standardized scheme such as two way ranging (TWR) defined in the IEEE 802.15.4a, round-trip delay (RTD) defined in the IS-95 series or round-trip time (RTT) defined in the UMTS, and may be approximately estimated by a relative difference between the intensity RSS of the received signal and the intensity TSS of the signal transmitted from the terminal. In general, if the master terminal 200 and the slave terminal 300 generate signals with adequately small intensity and the connection stage (511) is successfully finished, it is assumed that the two terminals are close to each other. Accordingly, the distance between the terminals is measured according to the sixth implementation example of the present disclosure so as to confirm that the terminals are close to each other.

A next stage is a frequency measurement stage (513) in which either or both of the master terminal 200 and the slave terminal 300 measure the frequency error of the counterpart's terminal. In the present disclosure, it is assumed that the master terminal 200 and the slave terminal 300 perform transmission and reception at a specific frequency via the same air interface. Accordingly, the terminal is aware of the transmission frequency of the counterpart's terminal. Thus, by measuring the frequency of the signal received from the counterpart's terminal and comparing the frequency of the counterpart's terminal with the estimated frequency, it can recognize a difference between the frequencies (relative frequency error) (If the master terminal 200 corrects the frequency using the GPS signal, the frequency error of the master terminal 200 is reduced to a negligible degree and, if the master terminal 200 which performs precise correction receives the signal transmitted from the slave terminal 300 and measures the frequency error of the slave terminal 300, the measured frequency error of the slave terminal 300 may be regarded not only as a relative frequency error but also as an absolute frequency error.). If the master terminal 200 and the slave terminal 300 use the oscillators 221, 321 for generating the reference frequency signal and use the same frequency dividers 222, 322, since the measured relative (or absolute) frequency error of the counterpart's terminal is generated due to the relative (or absolute) frequency error of the oscillator 221 or 321 of the counterpart's terminal, one terminal may measure the relative (or absolute) frequency error of the oscillator 221 or 321 of the other terminal. If the observer of the relative frequency error is the master terminal 200, information obtained by compensating for the frequency error of the slave terminal 300 with the Doppler frequency value of each GPS satellite included in the assistance transmitted to the slave terminal 300 is delivered. If the GPS Doppler frequency, with which the frequency error of the slave terminal 300 is compensated, is not included in the assistance generated by the master terminal 200, the master terminal 300 may inform the slave terminal 200 of the relative (or absolute) frequency error of the slave terminal 300 using an additional parameter or signal. If the observer of the frequency error is the slave terminal 300, the slave terminal computes the compensation value for the frequency error component of the oscillator 321 from the Doppler frequency value of the GPS satellite included in the assistance received from the master terminal 20 and computes the Doppler frequency of the GPS satellite. The frequency measurement stage 513 may be performed prior to or simultaneously with the ranging stage 512.

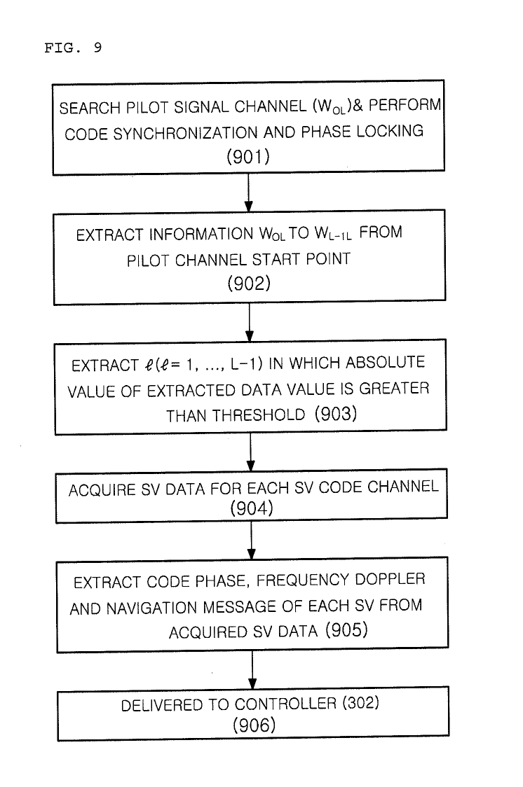

If the assistance is delivered upon the request of the slave terminal 300 in the connection stage 511 instead of being broadcasting by the master terminal 200, a next stage is an assistance deliver stage 514 as shown in FIG. 5. In a specific implementation example of the present disclosure, the code phase and the Doppler frequency information of each GPS receiver included in the assistance are generated not based on a time when the assistance is generated by the master terminal 200 or a previous time thereof, but based on a future time. For example, the master terminal 200 generates a valid assistance just after a time obtained by adding a time when any information is transmitted through the communication units 241, 242, and a time when the transmitted information is received by the slave terminal 300 and is appropriately processed by the controller 320, and delivers the assistance to the slave terminal 300. The assistance includes the key information shown in FIG. 9 and may be delivered through a communication signal as shown in FIG. 8 or in the form of a message as in the existing A-GPS.

The slave terminal 300 which acquires the assistance in the stage 514 searches for each GPS signal, and continuously tracks the searched GPS satellite signal in a signal search and acquisition stage 531. As described above, the GPS satellite signal search of the stage 531 is performed rapidly due to a very small Doppler frequency search range and a very small code phase search range based on the assistance, and the slave terminal 300 provides the code phase information of the received signal for estimating the pseudorange while continuously tracking the Doppler frequency and the code phase information of the searched GPS.

The slave terminal 300 which searches for and acquires a plurality of GPS satellite signals in the signal search and acquisition stage 531 performs GPS position determination using navigation message information (i.e., the information necessary for GPS position determination from among the information extracted from the message of the GPS satellite by the slave terminal 300, such as orbit information of each GPS satellite, time error information of the satellite, or ionospheric layer error correction information of the satellite) of each GPS satellite included in the assistance of FIG. 6 (532; position fix).

The stages 531 and 532 are also performed with the existing GPS receiver but are different from the existing GPS receiver in that the area is a lot smaller than the search area of the existing GPS receiver, and only a smaller search area than that of the A-GPS receiver of Qualcomm Inc. may be searched in the stage 531.

In another embodiment, the ranging stage 512 may be performed repeatedly plural times so as to perform the distance measurement plural times and an average value thereof may be obtained, thereby increasing accuracy of the distance measurement. In addition, the relative movement of the slave terminal 300 and the master terminal 200 may be detected by performing distance measurement several times. That is, if the relative distance between the slave terminal 300 and the master terminal 200 is constant, the slave terminal 300 and the master terminal 200 may be moving together or the slave terminal 300 and the master terminal 200 may be fixed. Accordingly, the Doppler frequency value of the GPS satellite signal observed in the master terminal 200 and the Doppler frequency value of the GPS satellite signal received by the slave terminal 300 may be the same. In this case, more accurate Doppler frequency error information may be included in the assistance so as to be delivered to the slave terminal 300, and the slave terminal 300 may perform accurate GPS satellite signal search using the more accurate Doppler frequency information.

In another embodiment, the frequency measurement stage 513 may be performed repeatedly plural times so as to perform frequency measurement plural times an average value thereof may be obtained, thereby increasing accuracy of the relative (or absolute) frequency error measurement.

To express the assistance of the assistance generation and delivery stage 514 by messages defined in the IS-801, acquisition assistance is included as mandatory information. Further, sensitivity assistance, GPS almanac, GPS ephemeris, GPS almanac correction, GPS navigation message bits, GPS location assistance, and position information of the master terminal may be included.

The operation flow of the present disclosure shown in FIG. 5 may be performed in the following order:

stage 510->stage 511 (broadcasting scheme)->stage 531 ->stage 532,

stage 510->stage 511 (non-broadcasting scheme)->stage 512->stage 513->stage 514->stage 531->stage 532,

stage 510->stage 511 (non-broadcasting scheme)->stage 513->stage 512->stage 514->stage 531->stage 532,

stage 510->stage 511 (non-broadcasting scheme)->stage 512->stage 514->stage 531->stage 532,

stage 510->stage 511 (non-broadcasting scheme)->stage 513->stage 514->stage 531->stage 532, or

stage 510->stage 511 (non-broadcasting scheme)->stage 514->stage 531->stage 532.

The assistance transmitted from the master terminal 200 in the stage 514 is different from that of the IS-801, as follows.

First, while the base station is used as a reference point in the case of the IS-801, the master terminal 200 is used as a reference point in the present disclosure. Thus, the assistance transmitted from the master terminal 200 in the stage 517 is different from that of the IS-801 in temporal expression (In all other cases, data of the same format may be used.). That is, time information used in the acquisition assistance may be generated based on a reference time different from that of the existing A-GPS. The time information of the present disclosure may use (a) a start time of a first bit of a specific message transmitted from the master terminal 200, (b) a transmission time of a specific signal transmitted from the master terminal 200, or (c) a start time of a spread-spectrum code (pseudonoise code) repeated when spread-spectrum wireless communication is employed) as a reference time. The three times ((a), (b) and (c)) are recognized by the slave terminal 300 as time information in the process in which the slave terminal 300 which receives the signal transmitted from the master terminal 200 searches for the signal of the master terminal 200. Accordingly, processing delay may occur in the process of searching for and processing the signal of the slave terminal 300 and the processing delay may become a time synchronization error element. If the processing delay value has a constant average (or if the measured average value is known), the processing delay value may be compensated for by the slave terminal 300, thereby performing more accurate time synchronization.

Second, if the master terminal 200 is aware of the distance measurement value between the master terminal 200 and the slave terminal 300, the mater terminal 200 may add the position information of the master terminal 200 and the distance measurement information between the master terminal 200 and the slave terminal 300 to the assistance and send the assistance (If the slave terminal 300 is aware of the measurement value, the sending of the distance measurement information is omitted.).

Third, the assistance transmitted from the master terminal 200 in the stage 514 is different from that of the IS-801 in that more accurate code change rate and frequency change rate of each GPS satellite are delivered. If the master terminal 200 and the slave terminal 300 are close to each other and the distance therebetween is substantially constant, it may be assumed that the master terminal 200 and the slave terminal 300 move together or are fixed. Accordingly, the time-change rate (including the code Doppler) of the code rate of each GPS satellite signal, the Doppler frequency and the time-change rate of the Doppler frequency, which are observed by the master terminal 200, are equally observed by the slave terminal 300. Such information is used when the slave terminal 300 searches for the GPS satellite signal using the correlator and acquires the signal, thereby performing efficient, high-sensitivity signal search/acquisition.

Fourth, the assistance transmitted from the master terminal 200 in the stage 514 is different from that of the IS-801 in that the frequency error of the slave terminal 300 or the accurate frequency value of the GPS satellite signal in consideration of the frequency error of the slave terminal 300 is delivered.

Fifth, the format of the assistance does not follow the message standard of the mobile communication as in the IS-801. A part of the assistance includes immediate assistance immediately necessary for immediate signal search in the slave terminal 300 and the remaining information includes later assistance necessary to finally compute the position after the slave terminal 300 successfully searches for and acquires the GPS signal. Accordingly, in the present disclosure, the slave terminal 300 may easily acquire immediate information by delivering the immediate assistance after performing orthogonal and direct spreading without following the message format. The immediate assistance includes the code phase and Doppler frequency information of each GPS satellite valid at a specific time of the immediate future based on a time when the master terminal 200 generates the assistance.

In a first implementation example of the present disclosure, the assistance is generated in the form of a message and is delivered in a state of being carried in a signal, similarly to the scheme of the IS-801. Such a scheme is not suitable when fast information delivery is necessary, because the slave terminal 300 has to receive the signal of the master terminal 200, find a message from the received signal, and restore (decode) the message information. In the case of the A-GPS of Qualcomm Inc., unnecessary time delay occurs due to the process of generating the assistance in the form of a message according to the IS-801 standard and carrying and sending the message in a data channel frame between the base station and the terminal. Thus, immediate information acquisition is impossible, but time delay of tens of msec occurs due to the post-processing procedure of restoring the message from the data frame.

In a second implementation example of the present disclosure, inefficient time delay of the first implementation example is omitted so as to deliver the immediate assistance more rapidly to the slave terminal 300. A method of simply delivering the assistance using a spread-spectrum scheme such that the slave terminal 300 directly acquires the assistance from the received signal is used. As the information extraction scheme using the signal, an information delivery scheme using a time-division multiplexing (TDM) modulation scheme, a phase-division multiplexing (PDM) modulation scheme, a frequency-division multiplexing (FDM) modulation scheme or a code-division multiplexing (CDM) modulation scheme may be implemented. FIG. 7 shows a scheme for delivering the assistance using a CDM scheme as a specific implementation example.

FIG. 7 shows an implementation example of generating a quadrature phase-shift keying (QPSK) spread-spectrum signal for delivering satellite information through an orthogonal code channel. For reference, the generation of the signal including the assistance shown in FIG. 7 is performed by the wireless communication modem 242 of the master terminal 200. In the QPSK scheme, an in-phase channel (hereinafter, referred to as I channel) is used to deliver code phase information of each GPS (GNSS) satellite and information included in a navigation message of the GPS (GNSS) satellite. A block 701 generates data Dᵢ^{I}(t) of Rb bit per second (bps) representing code phase prediction information of a specific immediate future time (t=T_effective) of an i-th GPS satellite (for example, a GPS satellite i, i=1, 2, 3, . . . , k) and spreads the data Dᵢ^{I}(t) to an i-th Walsh code W_{i,L} (i=1, 2, 3, . . . , k, k denotes the total number of satellites, k<L−1) having a length L allocated to the i-th satellite (i=1, 2, 3, . . . , k, k denotes the total number of satellites, k<L−1). Although the scheme for allocating the i-th satellite to the channel orthogonally spread to the i-th Walsh code W_{i,L} is shown for convenience of description, in the actual implementation, the i-th satellite may not correspond to the i-th Walsh code. The correspondence between the satellite number and the orthogonal channel number may be delivered through another surplus orthogonal channel. According, the spread signal has Rc (==Rb*L) cps (chip per second) (That is, the code rate of the Walsh code also has Rc cps. In the present disclosure, Rb=50 bps and L=8 are assumed as a minimum value.). The length L (=2^{S}, S is a natural integer) of the Walsh code is determined based on the total number of satellites belonging to the GNSS satellite system in which the assistance will be delivered. For example, when considering all the GPS satellites, since the total number of satellites available globally as of 2010 is 31 (k=31), L>31 (that is, S=5) is obtained. In 2020, when all the GPS (31), GLONASS (24), Galileo (27) and Compass (35) satellites are operated, L>117 (that is, k=117, S=7) is obtained. If the total number of satellites is extremely large or only the code phase information of the satellites which can be currently observed is desired to be delivered, the master terminal 200 must deliver a list of satellites included in the assistance delivered using the scheme of FIG. 7 to the slave terminal 300. In this case, k may become a smaller value and L may also become a smaller value. If a smaller value k is used while maintaining the value L (that is, the number of satellites is reduced), the code phase and Doppler frequency prediction data of the GPS satellite which does not send the assistance is set to 0 (physical value) and the output of the code channel is physically set to 0.

The start point of every data bit of the I channel and quadrature-phase channel (hereinafter, referred to as Q channel) assistance is synchronized with a first chip of the Walsh code, and an end point of every data bit is synchronized with a last chip of the Walsh code. That is, one data bit is orthogonally spread to one Walsh code. In addition, the start chip of the PN code of the I/Q channel is synchronized with the start chip of the Walsh code, and the last chip of the PN code of the I/Q channel is synchronized with the last chip of the Walsh code.

Among the L Walsh codes having the length L, a 0th Walsh code (Walsh code having L logical values of 0) is used as a pilot channel (as in the IS-95) which does not include satellite data), k Walsh codes excluding the 0th Walsh code among the L Walsh codes are used for orthogonal spreading (702) of the code phase information of each satellite, and L-k−1 Walsh codes are used for orthogonal spreading (702) of the navigation message information of the satellite. The signal spread in the process 703 is arithmetically summed (703) and is directly spread to an I channel PN code (code rate Rc cps) (704) (Since the processes 702, 703 and 704 involve linear functions, the order of processes may be changed.). Thereafter, a block 705 performs frequency up conversion (multiplication by cos(ω₀t)) with an output frequency ω₀, and inputs the result to a block 721.

The implementation of the Q channel is very similar to that of the I channel. To describe the difference between the Q channel and the I channel, first, information directly spread to the i-th Walsh code (i=1, 2, 3, . . . , k) in the block 712 is data Dᵢ^{Q}(t) of Rb bit per second (bps) representing Doppler frequency prediction information of an i-th satellite at a specific immediate future time (t=T_effective). The data is orthogonally spread in a block 712, is arithmetically summed in a block 713, and is directly spread to a Q channel PN code (differently from the I channel PN code, Rc cps) in a block 714. A block 715 performs offset QPSK (OQPSK), which is not included in the I channel and may be selectively used if necessary. Both the case where the block 715 is included and the case where the block 715 is not included may become the implementation examples of the present disclosure. The output of the block 715 is subjected to frequency up conversion (multiplication by sin(ω₀t)), with the output frequency ω₀, and is input to a block 721. The block 721 arithmetically sums the I channel and Q channel, and inputs and transmits the sum to an antenna.

The lengths of the I channel and Q channel PN codes PN_{I} and PN_{Q} used in the blocks 704 and 714 may vary according to accuracy of the code phase information and the Doppler frequency information of the GNSS satellite. If the GPS L1 frequency C/A code has a length of 1023 chips and hypothesis search is performed in units of ½ chips, there are a total of 2045 code phase hypotheses. In order to represent the 2045 pieces of code phase information with respect to an i-th GPS satellite, a minimum of 11-bit information is necessary. If the satellite information of the GPS C/A code is represented in units of 1 chip instead of ½ chips, it may be represented by 10-bit information. If Bc-bit information is necessary to represent the code phase information of a certain GNSS satellite, the length L_{PN}_{_{—}}_{I} of the I channel PN code is equal to or greater than Bc*L. That is to say, L_{PN}_{_{—}}_{I}=Bc*L needs to be satisfied and a chip rate Rc has a sufficiently high value (Rc>>1000).

Similarly, in the block 711 of the Q channel, the length of the data Dᵢ^{Q}(t) is determined based on the frequency step size and the Doppler frequency range to represent the Doppler frequency information of the i-th GPS satellite. In a Doppler frequency range from −100 kHz to +100 kHz and a frequency search area having a frequency step size of 100 Hz, the Doppler frequency information of the i-th GPS satellite is one of 2001 (=100000/100*2+1) and Dᵢ^{Q}(t) is represented by Bf (=11 bits). Accordingly, the length L_{PN}_{_{—}}_{Q} of the Q channel PN code is equal to or greater than Bf*L. That is to say, L_{PN}_{_{—}}_{Q}=Bf*L needs to be satisfied and L_{PN}_{_{—}}_{I=L}_{PN}_{_{—}}_{Q}=max{Bc*L, Bf*L} (that is, the larger value of Bc*L and Bf*L) is selected for convenience of implementation.

A scheme for setting an end point of the last chip (code) of a current period of the I channel and Q channel PN codes PN_{I} and PN_{Q} used in the blocks 704 and 714 as the preferable value of T_effective is proposed. However, H_effective may be set to a value indicating a specific time of 1 second or less after the current time.

2k orthogonal channels allocated to the I channel and the Q channel are used to send the immediate assistance, and the remaining 2(L-k−1) orthogonal channels are used to distribute and deliver the navigation message data of k GNSS satellites to which the immediate assistance is delivered through the 2k orthogonal channels. If L>2K, since (L-k−1)=k, k orthogonal channels among the L-k−1 orthogonal channels may be allocated to the navigation message data of the k GNSS satellites to which the immediate assistance is delivered (This scheme is equally applied to both the I channel and the Q channel.).

The second implementation example of the present disclosure shown in FIG. 7 shows an example of using the CDM scheme among various signal modulation methods. Although the modulation method of transmitting a variety of information using the CDM scheme is shown in FIG. 7, the information may also be transmitted using the TDM, FDM or PDM scheme.

In the scheme shown in FIG. 7, since the embodiments of the present disclosure avoids time consumption due to the channel coding, frame formatting and decoding processes of the assistance in the scheme for representing the information in the message format defined in the IS-801 used in the A-GPS scheme of Qualcomm Inc., a faster assistance delivery scheme for finding the transmitted information simultaneously with signal reception is implemented such that more fast GPS cold start is possible.

Since the scheme for generating the signal of the master terminal 200 shown in FIG. 7 is similar to the downlink used in the IS-95 CDMA mobile communication, the structure of the wireless communication receiver of the slave terminal 300 which receives the signal of FIG. 7 is similar to the structure of the CDMA receiver (IS-95 terminal (mobile station)). First, the module for searching for and acquiring the QPSK pilot signal (Walsh 0th code channel) of FIG. 7 is implemented using the same scheme as the module of the IS-95, and thus the description thereof will be omitted.

FIG. 7 shows the scheme of transmitting the signal of the Sᵢ-th GNSS satellite through the i-th orthogonal channel, in which the orthogonal channel for sending the immediate assistance is fixed to first to k-th orthogonal channels. However, in an actual implementation, this order is not absolute. That is to say, in a generalized implementation example, k orthogonal channels of a total of L orthogonal channels are used to send the immediate assistance, a 0th orthogonal channel is used as a pilot channel, and the remaining L-k−1 orthogonal channels are used to deliver the navigation message data of the GNSS satellite.

FIG. 8 shows an implementation example of the functional structure of the slave terminal 300 which rapidly acquires the assistance from the signal transmitted from the master terminal 200 shown in FIG. 7. First, the received signal input to the wireless communication modem 342 (the area denoted by a dotted line) is a baseband signal divided into in-phase and quadrature-phase (r_{I}(t) and r_{Q}(t); I and Q baseband signals) and the wireless communication modem is already in code (chip) level synchronization (chip level synchronization and I/Q channel phase synchronization of the PN code) through a pilot signal acquisition process.

The I and Q baseband inputs are de-spread to the PN_{I} code and the PN_{Q} code generated by a PN_{I} code generator 811 and a PN_{Q} code generator 812, which are synchronized with the respectively received pilot channels, and then are de-spread to L Walsh codes for generating the I and Q channel shown in FIG. 7. L parallel Walsh code de-spreaders of each of the I channel and the Q channel of FIG. 8 correspond to the L parallel Walsh code spreaders of each of the I channel and the Q channel of FIG. 7. The output of each Walsh code de-spreader of the I channel receiver of FIG. 8 is integrated during L chips (length of the Walsh code) in blocks 821 and 822. It is determined that successful data acquisition is performed if the integrated result is equal to or greater than a threshold TH, and it is found that an original data value is +1. On the contrary, if the result of integrating the output during the L chips is less than −TH, −1 is read. The result of the read code channel is delivered to the controller 320. The de-spreading by the Walsh code, L-chip signal integration and data acquisition are equally performed in the I channel and the Q channel. The threshold TH is delivered from the controller 320. Such a data acquisition scheme is widely used in a spread-spectrum communication system.

The acquired assistance data is input to the controller 320. The controller 320 generates a GNSS signal having the same code phase and Doppler frequency as the code phase and the Doppler frequency of a GPS satellite obtained from k code channels of the I channel and k code channels of the Q channel at T_effective, and searches for the GPS satellite signal received by the GPS signal processor 312. In the above process, the controller 320 controls the GPS signal processor 312 so as to sequentially search for the code phase and Doppler frequency in a slightly wider range than that of the received code phase and Doppler frequency in consideration of transmission and reception errors of the variety of information, time errors, etc. FIG. 8 shows the information about the code phase and Doppler frequency specified by the controller 320 delivered to signal searchers 851 to 853 of each GPS satellite.

In FIG. 8, the blocks 823-824 and 833-834 perform function for acquiring the GNSS navigation message information instead of the function for acquiring the code phase and Doppler frequency information of the GNSS satellite. The blocks 823-824 and 833-834 deliver information acquired by demodulating the code channels, through which the navigation message of the GNSS satellite shown in FIG. 7 is delivered, to the controller 320. The controller 320 outputs the navigation message information of the acquired GNSS satellite to the computation processor 332 so as to use the navigation message information to compute the accurate position measurement of the slave terminal.

FIG. 9 is a flowchart illustrating the function of the wireless communication modem 342 of the slave terminal 300 shown in FIG. 8.

First, in step 901, the slave terminal 300 searches for a pilot channel (a code channel spread to a 0th Walsh code) and performs code synchronization and phase locking through the searched pilot channel, in order to search for a signal transmitted from the master terminal 200. The slave terminal 300 de-spreads each code channel in step 902, integrates the de-spreading result value by the length L of the Walsh code in step 903, compares the integrated result value with a threshold, and acquires original assistance data (904). The code phase and Doppler frequency information of each GNSS satellite signal and the navigation message information is delivered to the controller 320 (906).

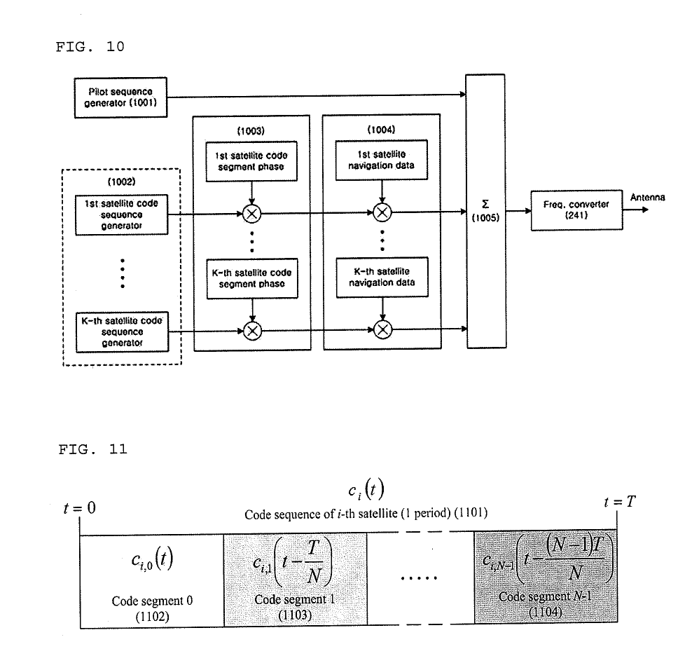

FIG. 10 is a diagram showing an implementation example of the transmitter of the wireless communication modem 242 of the master terminal 300 which performs the role similar to a repeater for reconfiguring and transmitting the GNSS satellite signal as another example of the second implementation example of the present disclosure shown in FIG. 7. First, a pilot sequence generator 1001 of FIG. 10 generates a PN code with a period T_{P}. A satellite signal generator 1002 generates a code signal (a Gold code signal in the case of the GPS) of each GNSS satellite having the same phase as the currently received code phase of the GNSS satellite. The satellite signal output from the satellite signal generator 1002 is divided into N code segments 1102-1104 having the same length in every satellite signal 1101 (with a period of T) as shown in FIG. 11. The phase of the signal generated by the satellite signal generator 1002 is rotated in code segment units by a phase value generated by a code segment phase rotator 1003. The phase rotation value per code segment of each satellite is determined by the Doppler frequency of the satellite and the number of the code segment. For example, when the Doppler frequency of an i-th satellite signal currently received by the master terminal 200 is Δfᵢ, the phase of an n-th code segment of the satellite may be rotated by 2 nnΔfᵢ.

Next, each satellite signal is multiplied by the navigation information of the satellite (1004). In the case of the GPS, although the navigation information has a transfer rate of 50 bps, the transfer rate may be increased for faster transmission of navigation information. For example, if the code of every period is multiplied by different navigation information bits, the code period T of the GPS is 1 ms and a navigation information transfer rate of 1 kbps is obtained (20 times of the data rate of the existing GPS). The pilot signal and the satellite code generated by the above process are summed in a block 1005, are up converted in a block 241, and are transmitted via an antenna.

FIG. 12 is a diagram showing a frequency synchronization process of the receiver of the wireless communication modem 342 of the slave terminal 300, which receives the signal transmitted from the master terminal 200 shown in FIG. 10 and acquires the assistance. The received signal 1201 of the wireless communication modem 342 of the slave terminal is a complex signal 1201 including the I channel and the Q channel. An autocorrelator 1202 of FIG. 12 obtains an autocorrelation value having a length of Tₚ of the received complex signal Rx(t). At this time, if an adequate value (for example, Tₚ=M*T with M a real number>1) is selected such that Tₚ is not equal to the period T of the code, each satellite signal is removed by the autocorrelation characteristics of the PN code and only an autocorrelation value by the pilot signal remains. In FIG. 12, the autocorrelation value of the received complex signal Rx(t) having the length Tₚ is output, by dividing Rx(t) into time-divided signal components having a time length of Tₚ/V (V>>1), multiplying a time-divided signal component r(t+Tₚ) obtained after a time having a length of Tₚ by a complex conjugate signal r(t)* of one time-divided signal component r(t) so as to a multiplied result, and arithmetically summing the Tₚ/V results obtained by performing multiplication with respect to all the time-divided signal components during the period Tₚ. Since frequency error of δf₀ occurs between the master terminal 200 and the slave terminal 300, the arithmetically summed value obtained by the autocorrelation process is associated with the phase rotation value generated by the frequency error during the time Tₚ. Through this association, a block 1203 obtains an estimation value of the frequency error. In the block 1203, on the assumption that V=Tₚ, an arithmetic average 1/Tₚ and a phase ∠Y of the result of arithmetically summing the Tₚ multiplied values are computed so as to output an estimation frequency error δ\hat{ƒ}₀. Accordingly, using the estimation frequency error δ\hat{ƒ}₀, the frequency error between the master terminal 200 and the slave terminal 300 can be corrected. The wireless communication modem 342 of the slave terminal 300 obtains the estimation frequency error δ\hat{ƒ}₀, and then compensates for the estimation frequency error δ\hat{ƒ}₀ in the communication signal of the master terminal 200.

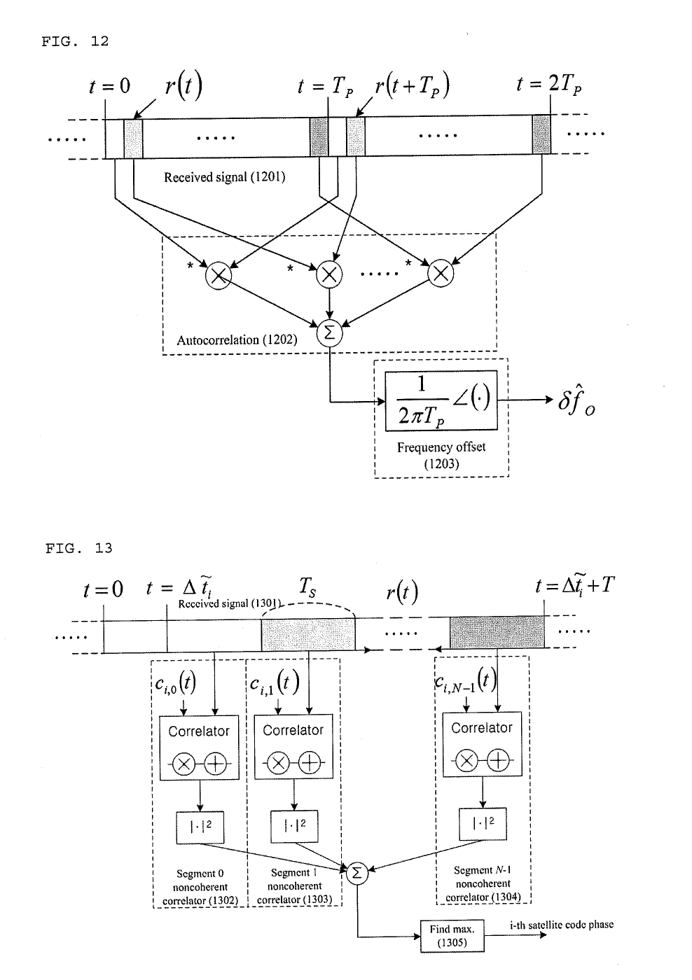

FIG. 13 is a process of acquiring the code phase of each GNSS satellite signal from the received signal Rx′(t) 3101, the frequency error of which is corrected through the frequency synchronization process of FIG. 12, through another correlation process in the wireless communication modem 342 of the slave terminal 300. FIG. 13 shows the signal processing of the wireless communication modem 342 of an i-th satellite signal. The autocorrelation value of the i-th satellite signal is obtained by performing noncoherent correlations 1302-1304 with respect to the received signal Rx′ (t), the frequency error of which is corrected, in code segment units and arithmetically summing the result. The autocorrelation value is computed with respect to all code phase hypotheses of the i-th satellite, a maximum value is selected from the autocorrelation values obtained with respect to all the code phase hypotheses (1305), and the code phase corresponding to the maximum value is used as the currently received code phase estimate of the i-th satellite. The code phase estimate of the i-th satellite is delivered to the controller 320 and the information is delivered from the controller to the GPS signal processor 312, thereby performing the search of the i-th satellite according to the code phase estimate of the i-th phase. That is, the GPS signal processor 312 sets an adequate code phase hypothesis interval in order to rapidly search for and acquire the i-th GNSS satellite signal. The functional connection between the controller and the GNSS satellite searcher is described in the description of FIGS. 4b and 8.

If the code phases of the GNSS satellite delivered from the master terminal 200 through the assistance are found and the code synchronization with the received GNSS satellite signals is performed by the process of FIG. 13, the phase rotation value per code segment can be obtained in the block 1003 of FIG. 10 from the outputs of the autocorrelators 1302-1304 per code segment shown in FIG. 13. The autocorrelators have a correlation length of Ts as shown, where Ts denotes the time length of the segment. Since these values represent the Doppler frequency information of the satellite, the Doppler frequency of the satellite can be obtained from the autocorrelation output per code segment. The Doppler frequency information of each GNSS satellite obtained in this process is also delivered to the controller 320 and is delivered from the controller 320 to the GPS signal processor 312, thereby setting an adequate hypothesis interval, for fast GNSS satellite signal search and acquisition.

Finally, a process of acquiring spread-spectrum navigation information in a block 1004 of FIG. 10 is necessary. Since navigation information is multiplied by the spread code of each satellite, if the code phase and the Doppler frequency per satellite are obtained in the above process, the navigation information can be easily obtained using generally used methods in a spread-spectrum communication system.

According to embodiments of the present disclosure, it is possible to perform fast initial position measurement as compared to the existing A-GPS technique, achieve direct communication between two GPS receivers regardless of presence/absence of a mobile communication network, and resolve various limitations of the A-GPS technique. Since a hypothesis search area for searching for a GPS signal is significantly reduced by direct communication between two adjacent GPS receivers, fast accurate position measurement is possible as compared to the A-GPS. In addition, by using a direct spread type communication scheme in which a data processing scheme is simple in a receiver, fast assistance delivery and acquisition are possible.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method of acquiring an ultra-fast global navigation satellite systems (GNSS) initial position with peer assistance, the method comprising:
when a master terminal connected to a slave terminal in wireless communication generates assistance for acquiring a Global Positioning System (GPS) satellite signal of the slave terminal, generating assistance at a slave terminal;
at the slave terminal, searching for the GPS satellite signal based on the assistance;
computing a pseudorange using the result of searching for the GPS satellite signal;
computing the position of the slave terminal using the assistance and the pseudorange; and
searching for and tracking the GPS satellite signal based on the computed position.

2. The method according to claim 1, wherein the searching for the GPS satellite signal based on the assistance includes searching for the GPS satellite signal based on immediate assistance of the assistance, and the computing of the position of the slave terminal includes computing the position of the slave terminal using later assistance of the assistance and the pseudorange.

3. The method according to claim 2, wherein the immediate assistance is delivered from the master terminal to the slave terminal through a signal modulated using a signal modulation parameter in a signal modulation process without encoding.

4. A method of acquiring an ultra-fast global navigation satellite systems (GNSS) initial position with peer assistance, the method comprising:
at a slave terminal, receiving assistance generated using at least one of relative frequency error obtained by a master terminal or the slave terminal or a distance from the master terminal to the slave terminal;
at the slave terminal, searching for a Global Positioning System (GPS) satellite signal based on the assistance;
computing a pseudorange using the result of searching for the GPS satellite signal;
computing the position of the slave terminal using the assistance and the pseudorange; and
searching for and tracking the GPS satellite signal based on the computed position.

5. The method according to claim 4, wherein: the searching of the GPS satellite signal includes searching for the GPS satellite signal based on immediate assistance acquired only by acquisition of a baseband input signal of the assistance, and the computing of the position of the slave terminal includes computing the position of the slave terminal using later assistance of the assistance and the pseudorange.

6. The method according to claim 5, wherein the immediate assistance includes a code phase and a Doppler frequency of the GPS satellite signal.

7. The method according to claim 5, wherein the immediate assistance is delivered from the master terminal to the slave terminal through a signal modulated using a signal modulation parameter in a signal modulation process without encoding.

8. The method according to claim 4, wherein the signal is modulated using any one of a time-division multiplexing (TDM) modulation scheme, a phase-division multiplexing (PDM) modulation scheme, a frequency-division multiplexing (FDM) modulation scheme or a code-division multiplexing (CDM) modulation scheme.

9. The method according to claim 4, wherein the assistance includes at least one of position information of the master terminal or distance measurement information between the master terminal and the slave terminal.

10. The method according to claim 4, wherein the assistance includes at least one of frequency error of the slave terminal measured by the master terminal or a Doppler frequency value of a GPS satellite signal to which the frequency error is applied.

11. The method according to claim 4, wherein the searching of the GPS satellite signal based on the assistance includes, if none of frequency error of the slave terminal measured by the master terminal or a Doppler frequency value of a GPS satellite signal, the frequency error of which is compensated for, is included in the assistance, correcting the frequency error of the master terminal measured by the slave terminal in the Doppler frequency value of the GPS satellite signal included in the assistance and acquiring the GPS satellite signal.

12. The method according to claim 4, wherein the signal is modulated using any one of a scheme including a pilot signal such that the slave terminal estimates channel and frequency error between the master terminal and the slave terminal or a scheme for modulating the signal itself.

13. A computer-readable recording medium having recorded thereon a program for executing the method according to claim 1 on a computer system.

14. An apparatus for acquiring an ultra-fast global navigation satellite systems (GNSS) initial position with peer assistance, the apparatus comprising:
a communication unit configured to receive assistance generated by a master terminal;
a computation processor configured to compute a pseudorange using a result of searching for a Global Positioning System (GPS) satellite signal by a GPS receiver and compute the position of a slave terminal using the assistance and the pseudorange; and
the GPS receiver configured to search for the GPS satellite signal based on the assistance and search for and track the GPS satellite signal based on the position of the slave terminal,
wherein the assistance is generated using at least one of frequency error obtained by the master terminal or a distance from the master terminal to the slave terminal.

15. The apparatus according to claim 14, wherein: the GPS receiver searches for the GPS satellite signal based on immediate assistance acquired only by demodulation of a baseband input signal of the assistance, and the computation processor computes the position of the slave terminal using later assistance of the assistance and the pseudorange.

16. The apparatus according to claim 15, wherein the immediate assistance is delivered from the master terminal to the slave terminal through a signal modulated using a signal modulation parameter in a signal modulation process without encoding.

17. The apparatus according to claim 15, wherein the immediate assistance includes a code phase and a Doppler frequency of the GPS satellite signal.

18. An apparatus for acquiring an ultra-fast global navigation satellite systems (GNSS) initial position with peer assistance, the apparatus comprising:
a master terminal which successfully performs Global Positioning System (GPS) position measurement; and
a slave terminal which receives assistance generated by the master terminal using a communication unit at a time when a GPS receiver starts up,
wherein the slave terminal includes:
a computation processor configured to compute a pseudorange using a result of searching for a GPS satellite signal by the GPS receiver and compute the position of the slave terminal using the assistance and the pseudorange; and
the GPS receiver configured to search for the GPS satellite signal based on the assistance and search for and track the GPS satellite signal based on the position of the slave terminal, and
wherein the assistance is generated using at least one of frequency error obtained by the master terminal or the slave terminal or a distance from the master terminal to the slave terminal.

19. The apparatus according to claim 18, wherein the master terminal generates immediate assistance acquired in a process of demodulating the signal received by the slave terminal so as to be used to search for the GPS satellite signal and later assistance delivered later in the assistance so as to be used to compute the position of the slave terminal.

20. The apparatus according to claim 18, wherein the immediate assistance includes a code phase and a Doppler frequency of the GPS satellite signal.
